(19) United States
(12) Patent Application Publication
(10) Pub. No.: US 2008/0146191 A1
(43) Pub. Date: Jun. 19, 2008

(54) Accounting control method and device

(75) Inventors: Toru Matsukuma, Fukuoka (JP); Toshihiro Morikawa, Fukuoka (JP); Koki Shigaki, Fukuoka (JP); Yoshiyuki Seguchi, Fukuoka (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/976,517

(22) Filed: Oct. 25, 2007

(30) Foreign Application Priority Data
Dec. 19, 2006 (JP) 2006-341658

(51) Int. Cl. H04M 11/00

(52) U.S. Cl. 455/406

(57) ABSTRACT

In a method and device which prevent unnecessary accounting from being performed when a communication deteriorated state occurs in a mobile terminal, a communication deteriorated state is detected in a state where a location registration is performed to a mobile radio communication network, a duration of the communication deteriorated state is detected, and cut of the duration from a duration of accounting is notified to the mobile radio communication network. With the notification, the mobile radio communication network changes accounting for the mobile terminal in the communication deteriorated state. Also, as the above-mentioned communication deteriorated state, there is e.g. a call disable state, a communication disable state during a voice/packet communication, or a communication disconnection state.

### BACKGROUND OF THE INVENTION

1. Field of the Invention

The present invention relates to an accounting control method and device, and in particular to an accounting control method and device by monitoring a mobile radio terminal connection in a mobile radio communication network.

2. Description of the Related Art

In a recent mobile communication network, a PDC system or a third-generation communication system (W-CDMA, cdma 2000) have become a main communication system. Hereafter, a provision of voice services using a wireless LAN and a debut of new carriers and a provision of new services are expected by an improvement of a mobile communication network based on a new communication system of WiMAX. Under these circumstances, it is an important issue for a carrier to differentiate provided services from those of other carriers to secure customers.

Although it is said that almost 100% of a service area of the mobile communication network is covered by numerous carriers in the prior art communication system, this numerical value is a total value calculated under base station setting conditions, where there are locally numerous areas outside of the base station service area due to a radio wave fault or shielding, and numerous out-of-service areas due to a dynamic factor (radio quality deterioration) exist, leading to a service gap among users.

Also, repletion of the service area can not be expected from the beginning by services provided in the above-mentioned new communication system. Therefore, it is considered to be important to eliminate a service gap by setting fees or the like according to a service quality (service area provided), as means of securing customers.

It is to be noted that there has been proposed a mobile terminal state determination system which stores within the terminal power on/off, a received radio wave intensity, and a service area or an out-of-service area state to which time information is attached to be transmitted to a base station as terminal information (see e.g. patent document 1).

Also, there have been proposed an accounting method and device which record the time when a mobile terminal has moved to an out-of-service area, manage an out-of-service staying time on a network side, and discount a base cost according to a service area as an example of using the recorded time and the out-of-service staying time (see e.g. patent document 2).
[Patent document 1] Japanese Patent Application Laid-open No. 2003-124870
[Patent document 2] Japanese Patent Application Laid-open No. 2003-78658

In the prior art mobile radio technology, a mobile radio communication network side periodically receives a location registration signal from a mobile terminal to manage the mobile terminal in a service area. When receiving no location registration signal from the mobile terminal within a fixed time and receiving no paging response from the mobile terminal even when a paging request is performed upon call arrival to the mobile terminal, the mobile radio communication network side determines that the mobile terminal has moved to the out-of-service area, so that registration information is cleared. Also, when the power is turned off while the mobile terminal is in the service area, the mobile radio communication network side receives a detach signal from the mobile terminal upon the power off, thereby enabling the management of the terminal state.

1) Thus, the mobile radio communication network side normally determines that the mobile terminal has moved to the out-of-service area in the absence of the location registration signal from the mobile terminal in a fixed duration. Therefore, the determination as to the movement to the out-of-service area on the mobile radio communication network side requires a fixed time, so that there has been a timing difference between the detection of “out-of-service”, i.e. a state where a user can not make a call at the mobile terminal, and the detection of that on the network, side.

This will be described as a case I shown in FIGS. 5A and 5B. A “call disable duration T1” detected by a mobile terminal 200 becomes a section where outgoing call and incoming call can not be made, i.e. services can not be enjoyed although a location registration has been already performed. Even though not a user but a service provider (mobile network sided control device 100) is responsible for call disable durations α1 and α2 in the call disable duration T1 (=call disable duration T1—out-of-service recognized duration T2), accounting is performed for the durations. The section where the user has turned power off is the out-of-service recognized duration T2, so that the service provider is not responsible for the section.

### 2) Also, there have been cases where a voice becomes difficult to be heard or intermittent due to a fluctuation or an instantaneous disconnection of a radio wave quality, or the like, so that a normal call (communication) quality is not satisfied.

This will be described as a case II shown in FIGS. 6A and 6B. When a radio quality during a call (communication) fluctuates in a state where the location registration has been already made, voice/packet communication disable durations β1-β3 occur. While the mobile terminal 200 recognizes that the terminal 200 itself is in the out-of-service area, the mobile network sided control device 100 requires the fixed time for detecting the movement toward the out-of-service area of the mobile terminal 200, so that accounting is unintentionally performed in some cases without the recognition of the out-of-service area.

3) Furthermore, there have been cases where a call disconnection due to a radio wave reception disable such as radio wave shielding occurs even during the call (communication) in the state where the location registration has been already made, and a communication disable duration occurs due to a reconnection operation caused by the call disconnection.

This will be described as a case III shown in FIGS. 7A and 7B. As an operation specific to the mobile terminal, reconnection durations γ1-γ3 caused by the detection of the communication disconnection exist. Namely, when a communication fault occurs between the mobile terminal 200 and the base station controlling an area where the mobile terminal 200 is located whereby the communication between the mobile terminal and the base station is disconnected, the mobile terminal repeats calling for reconnection for a preset time to hold a resource (communication state) of the concerned call, in order to avoid user's bother of a re-calling procedure. The time for which the mobile terminal performs calling for reconnection is a reconnection duration. Although the reconnection durations γ1-γ3 are communication disable durations for which the mobile terminal 200 can not communicate, the mobile network sided control device 100 can not detect “out-of-service”, so that accounting is performed.

### SUMMARY OF THE INVENTION

It is accordingly an object of the present invention to provide a method and device which prevent unnecessary accounting from being performed to a mobile radio communication network side when a communication deteriorated state occurs in a mobile terminal where a location registration has been performed.

In order to achieve the above-mentioned object, an accounting control method (or device) in a mobile radio communication network according to the present invention comprises: a first step of (first portion) detecting a communication deteriorated state in a state where a location registration is performed to the mobile radio communication network; a second step of (second portion) detecting a duration of the communication deteriorated state; and a third step of (third portion) notifying the mobile radio communication network to cut the duration from a duration of accounting.

The above-mentioned communication deteriorated state comprises e.g. a call disable state, communication disable state upon voice/packet communication, or a communication disconnected state.

Also, when the above-mentioned call disable state continues for equal to or more than a fixed duration, the notification is not required.

Namely, in the present invention, a mobile terminal side records a continuing duration of a state where the power of the mobile terminal is on and call can not be made in a service area (outside of service provided area), and a duration of a deteriorated state (communication deteriorated state) of a service quality (communication quality) due to a deterioration of a radio wave quality, an instantaneous disconnection, or the like. When the mobile terminal recovers from the communication deteriorated state, the duration is notified to the mobile radio communication network side. The mobile radio communication network side manages an out-of-service area time of the mobile terminal. Based on management information and the duration of the communication deteriorated state having received from the mobile terminal by the present invention, the time for which the mobile terminal has been staying outside of the service provided area and the communication disable duration are calculated, so that an accounting method is changed according to the information.

While in the prior art technology, only an out-of-service section managed by the mobile radio communication network side is grasped, in the present invention the “call disable duration” of the case I shown in FIGS. 5A and 5B is accurately managed on the network side in a state where the location registration is being maintained, so that accounting can be performed according to the service provided area.

Also, the case where the radio wave quality deteriorates and the instantaneous disconnection occurs in the state where the location registration is being maintained is difficult for the network side to detect the duration, in the same way as the cases II and III in FIGS. 6A, 6B, 7A, and 7B. However in the present invention, the radio wave quality deteriorated duration (duration of the communication deteriorated state) and the reconnection duration caused by the communication disconnection are measured by the mobile terminal side and notified to the network side, so that the network side can perform adequate accounting according to the service quality.

It is to be noted that both of “call” and “communication” in the following description are supposed to include “voice call and packet communication”.

According to the present invention, it becomes possible to dynamically grasp the communication deteriorated state per mobile terminal on the mobile radio communication network side. Thus, an accounting (fee setting) service according to the service quality (service cover area, call quality) can be realized, so that a service gap among customers can be eliminated.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an arrangement of an accounting control method and device according to the present invention;

FIG. 2 is a sequence diagram showing an operation example (1) by the arrangement of the present invention shown in FIG. 1;

FIG. 3 is a sequence diagram showing an operation example (2) by the arrangement of the present invention shown in FIG. 1;

FIG. 4 is a sequence diagram showing an operation example (3) by the arrangement of the present invention shown in FIG. 1;

FIGS. 5A and 5B are diagrams illustrating a prior art problem (case I);

FIGS. 6A and 6B are diagrams illustrating a prior art problem (case II); and

FIGS. 7A and 7B are diagrams illustrating a prior art problem (case III).

### DESCRIPTION OF THE EMBODIMENTS

Hereinafter, operation examples according to the present invention will be described referring to attached figures. It is to be noted that this embodiment does not cover a service non-providing duration caused by a power-off.

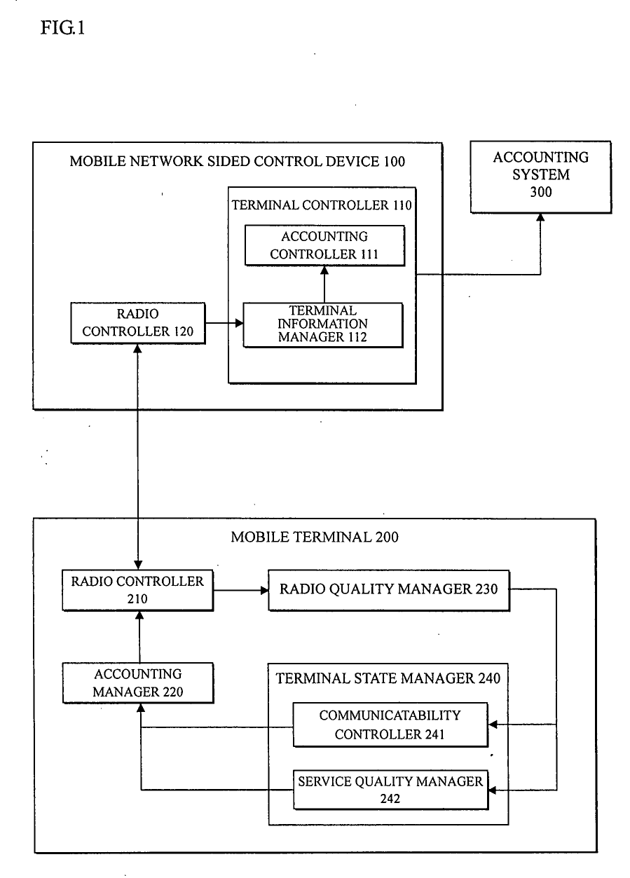

### Arrangement: FIG. 1

FIG. 1 shows a mobile radio communication system composed of a mobile network sided control device 100 and a mobile terminal 200 which realizes the present invention. The mobile network sided control device 100 is composed of a terminal controller 110 and a radio controller 120. The terminal controller 110 is further composed of an accounting controller 111 and a terminal information manager 112. Also, the mobile terminal 200 is composed of a radio controller 210, an accounting manager 220, a radio quality manager 230, and a terminal state manager 240. The terminal state manager 240 is further composed of a communicatability controller 241 and a service quality manager 242. Each of the portions has the following functions:

### Terminal controller 110: Managing information of the mobile terminal 200.

### Accounting controller 111: Managing accounting information.

### Terminal information manager 112: Managing call information and states of the mobile terminal 200.

### Radio controller 120: Performing radio connection control with the mobile terminal 200.

### Radio controller 210: Performing radio connection control with the mobile network sided control device 100.

### Accounting manager 220: Managing accounting information in the mobile terminal 200.

### Radio quality manager 230: Monitoring a radio quality in the mobile terminal 200.

### Terminal state manager 240: Managing a terminal state in the mobile terminal 200.

### Communicatability controller 241: Controlling communicatability in the mobile terminal 200.

### Service quality manager 242: Controlling a service quality in the mobile terminal 200.

### Accounting system 300: Database managing accounting information.

### Operation Example (1)

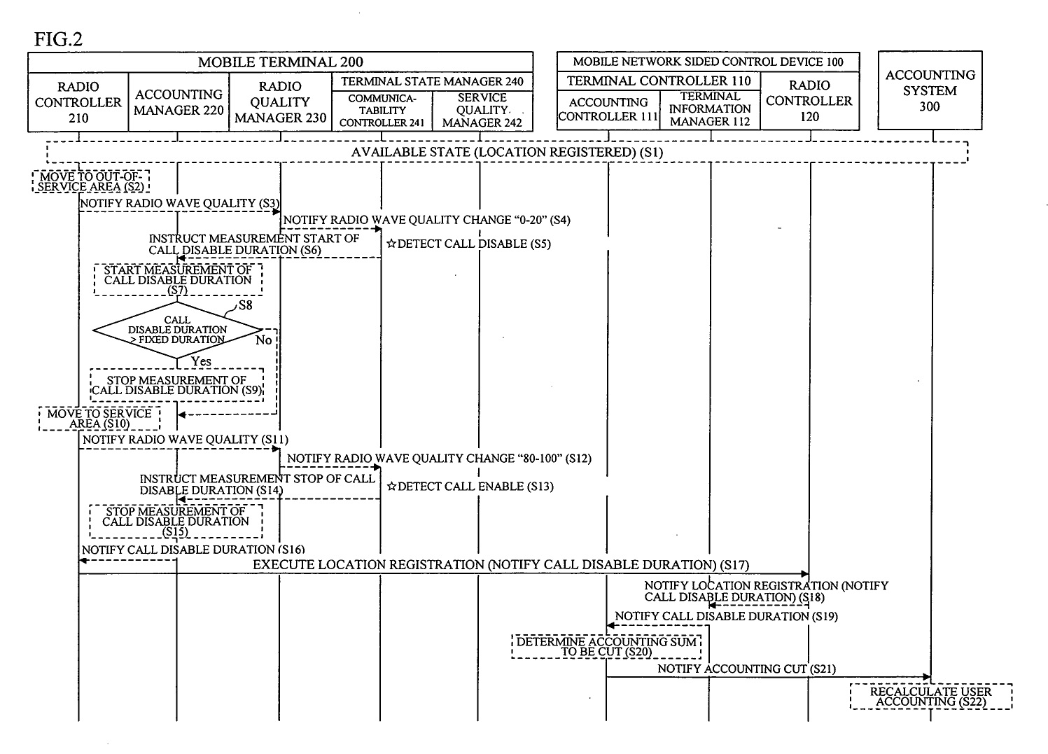

### FIG. 2 (Corresponding to Case I)

In this operation example, the mobile terminal 200 measures the “call disable duration” by measuring a radio wave quality and notifies the call disable duration to the mobile network sided control device 100, so that an accounting halt control is performed and the change of an accounting method is made possible in the accounting system 300.

Firstly, in the radio communication system shown in FIG. 1, where the location registration of the mobile terminal 200 has been already performed in the mobile network sided control device 100 (at step S1) (non-communication state) and the mobile terminal 200 moves to the out-of-service area (at step S2), the radio controller 210 measures the then radio wave quality to be notified to the radio quality manager 230 (at step S3). The radio quality manager 230 detects that the radio wave quality has changed to “0-20”. Since the radio wave quality <20, the radio wave quality change is notified to the communicatability controller 241 (at step S4). The indexes of the radio wave quality of detecting “out-of-service” (call disable or calling disable; communication disconnection) are made “0-20”, the indexes of the voice/packet communication disable quality are made “20-80”, and the indexes of the call enable (communicatable) quality are made “80-100”.

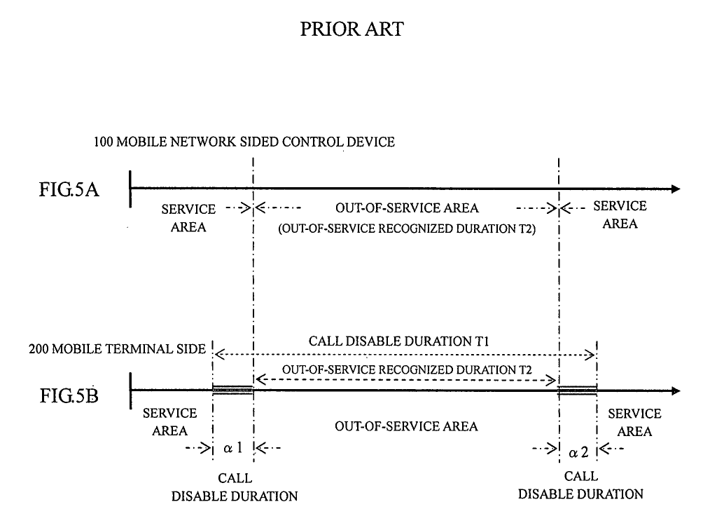

The communicatability controller 241 determines a call disable based on the notified radio wave quality values “0-20” (at step S5), and instructs' the accounting manager 220 to start the measurement of the call disable duration (call disable durations α1 and α2 in FIGS. 5A and 5B) (at step S6). Based on the instructions, the measurement of the call disable duration is started at the accounting manager 220 (at step S7).

The accounting manager 220 determines whether or not the call disable duration of which measurement has started is equal to or more than a fixed duration (at step S8). When it becomes equal to or more than the fixed duration, the measurement of the call disable duration is stopped (at step S9). This is because, as mentioned above, a call disable for more than the fixed duration is regarded that the mobile terminal has moved to the out-of-service area.

When the call disable duration does not reach the fixed duration, the measurement of the call disable duration is continued until the mobile terminal 200 re-moves to the service area. When the mobile terminal 200 moves to the out-of-service area (at step S10), the radio controller 210 notifies the then radio wave quality to the radio quality manager 230 (at step S11). The radio quality manager 230 detects the radio wave quality change “80-100” to be notified to the communicatability controller 241 (at step S12).

The communicatability controller 241 determines a “call enable” based on the notified radio wave quality values “80-100” (at step S13), and instructs the accounting manager 220 to stop the measurement of the call disable duration (at step S14). Based on the instructions, the accounting manager 220 stops the measurement of the call disable duration (at step S15). The call disable duration measured by the accounting manager 220 is notified to the radio controller 210 (at steps S16), and is further notified to the mobile radio communication network sided control device 100 from the radio controller 210 in synchronization with the operation of the location registration (at step S17).

The radio controller 110 notifies the call disable duration with a location registration request to the terminal information manager 112 (at step S18), which notifies the call disable duration to the accounting controller 111 (at step S19). The accounting controller 111 determines an accounting sum for cutting a base cost or the like based on the notified call disable duration (at step S20). Finally, an accounting cut is notified to the accounting system 300 from the accounting controller 241 (at step S21), so that user accounting is recalculated in the accounting system 300 (at step S22).

Thus, by measuring the call disable durations α1 and α2 of the case I shown in FIGS. 5A and 5B and notifying the durations to the mobile network sided control device 100, it becomes possible to reduce a cost burden (e.g. cut the base cost) on the user side in consideration of the call disable duration in an overall fee structure even if a call has not been started yet in the mobile network sided control device 100.

### Operation Example (2)

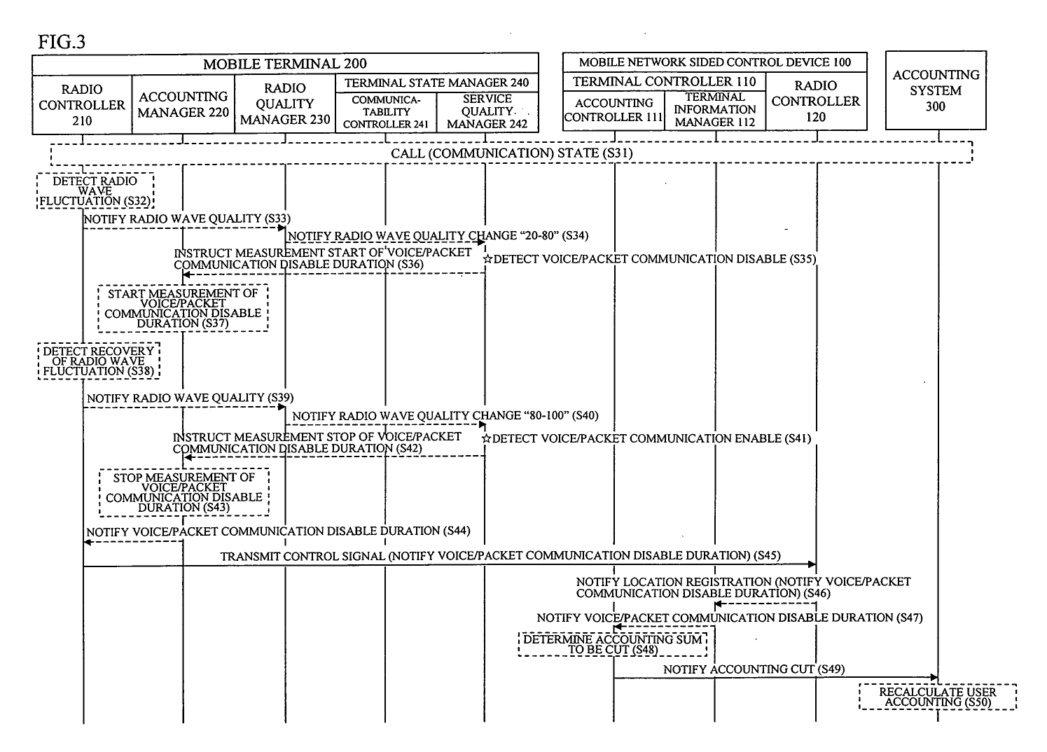

### FIG. 3 (Corresponding to Case II)

Firstly, when the mobile terminal 200 is in a call (communication) state (at step S31) through the location registration and the radio controller 210 detects the fluctuation of the radio wave (at step S32), the radio controller 210 notifies the then radio wave quality to the radio quality manager 230 (at step S33). Since the radio wave quality changes to “20-80” and the radio wave quality >20, the radio quality manager 230 notifies the radio wave quality change to the service quality manager 242 (at step S34).

The service quality manager 242 detects the voice/packet communication disable state caused by the radio wave quality deterioration based on the notified radio wave quality values “20-80” (at step S35), and instructs the accounting manager 220 to start the measurement of the voice/packet communication disable duration (at step S36). Based on the instructions, the accounting manager 220 starts the measurement of the voice/packet communication disable duration (at step S37).

Thereafter, when detecting the recovery of the fluctuation of the radio wave (at step S38), the radio controller 210 notifies the radio wave quality to the radio quality manager 230 (at step S39), which detects that the radio wave quality has changed to “80-100” to be notified to the service quality manager 242 (at step S40).

The service quality manager 242 determines that the voice/packet communication is enabled based on the notified radio wave quality values “80-100” (at step S41), and instructs the accounting manager 220 to stop the measurement of the voice/packet communication disable duration (at step S42). Based on the instructions, the accounting manager 220 stops the measurement of the voice/packet communication disable duration (at step S43).

The voice/packet communication disable duration measured by the accounting manager 220 is notified, with a control signal of a reconnection request, to the mobile network sided control device 100 from the radio controller 210 (at steps S44 and S45).

The operation thereafter is the same as that of the operation example (1) in which the call disable duration is replaced with the voice/packet communication disable duration (at steps S46-S50).

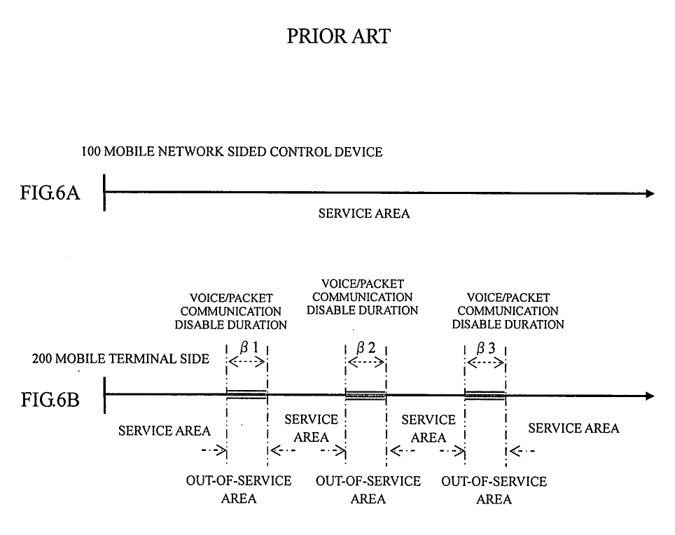

Thus, by measuring the voice/packet communication disable durations β1-β3 in the case II shown in FIGS. 6A and 6B and notifying the durations to the mobile network sided control device 100, it becomes possible to cut the fee for the communication disable durations β1-β3 from the fee of the voice/packet communication.

### Operation Example (3)

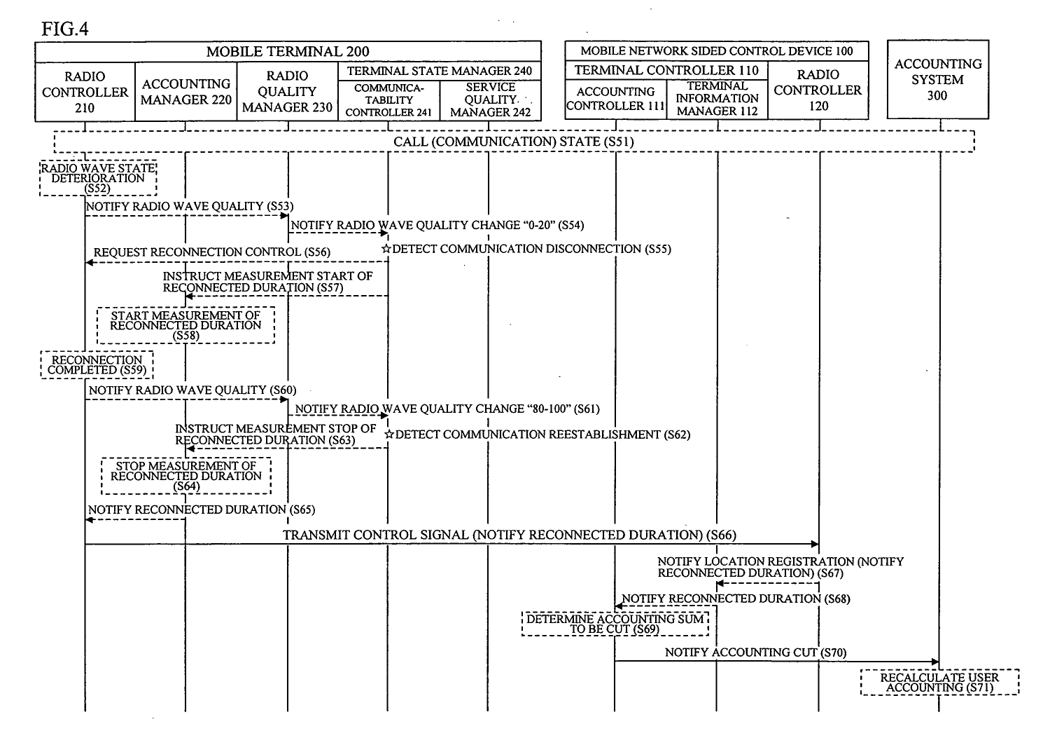

### FIG. 4 (Case III)

Firstly, when the mobile terminal 200 is in a call (communication) state through the location registration (at step S51) and the radio controller 210 detects the deterioration of the radio wave state (at step S52), the radio controller 210 notifies the then radio wave quality to the radio quality manager 230 (at step S53), which notifies the radio wave quality change “0-20” to the communicatability controller 241 in the same way as the operation example (1), since the radio wave quality in this case is equal to or less than 20 (at step S54).

The communicatability controller 241 detects the communication disconnection based on the notified radio wave quality values “0-20” (at step S55). However, since the previous state is the communication state, the communicatability controller 241 performs the reconnection request to the radio controller 210 (at step S56), and instructs the accounting manager 220 to start the measurement of the reconnection duration (at step S57). Thus, the accounting manager 220 starts the measurement of the reconnection duration (at step S58).

Thereafter, when completing the reconnection (at step S59), the radio controller 210 notifies the then radio wave quality to the radio quality manager 230 (at step S60), which detects the radio wave quality change “80-100” to be notified to the communicatability controller 241 (at step S61).

The communicatability controller 241 detects a reestablishment (reconnection completed) of the communication based on the notified radio wave quality values “80-100” (at step S62), and instructs the accounting manager 220 to stop the measurement of the reconnection duration (at step S63). Based on the instructions, the accounting manager 220 stops the measurement of the reconnection duration (at step S64).

The reconnection duration measured by the accounting manager 220 is notified to the mobile network sided control device 100 from the radio controller 210 upon transmission of the control signal (at steps S65 and S66).

The operation thereafter is the same as that of the operation example (1) in which the call disable duration is replaced with the reconnection duration (at steps S67-S71).

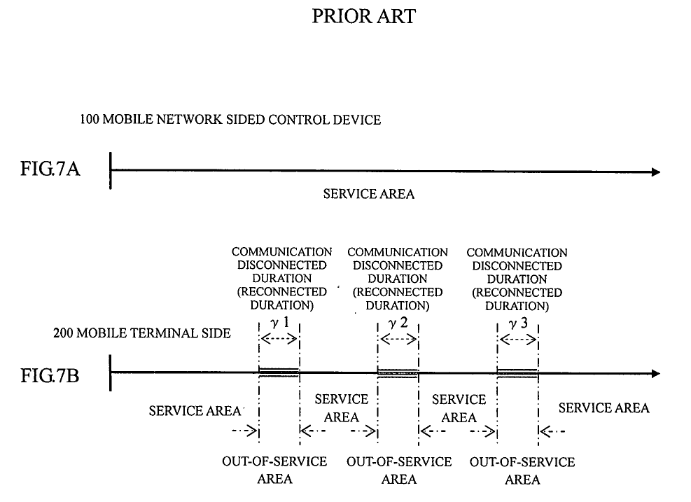

Thus, by measuring the communication disconnected duration (reconnection duration) γ1-γ3 in the case III shown in FIGS. 7A and 7B and notifying the durations to the mobile network sided control device 100, it becomes possible to cut the fee for the duration spent on the reconnection from the overall call (communication) fee.

It is to be noted that the present invention is not limited by the above-mentioned embodiments, and it is obvious that various modifications may be made by one skilled in the art based on the recitation of the claims.

What is claimed is:

1. An accounting control method in a mobile radio communication network comprising:
a first step of detecting a communication deteriorated state in a state where a location registration is performed to the mobile radio communication network;
a second step of detecting a duration of the communication deteriorated state; and
a third step of notifying the mobile radio communication network to cut the duration from a duration of accounting.

2. The accounting control method in the mobile radio communication network as claimed in claim 1, wherein the communication deteriorated state comprises a call disable state.

3. The accounting control method in the mobile radio communication network as claimed in claim 1, wherein the communication deteriorated state comprises a communication disable state during a voice/packet communication.

4. The accounting control method in the mobile radio communication network as claimed in claim 1, wherein the communication deteriorated state comprises a communication disconnection state.

5. The accounting control method in the mobile radio communication network as claimed in claim 2, wherein when the call disable state continues for more than a fixed duration, the notification is not performed.

6. An accounting control device in a mobile radio communication network comprising:
a first portion detecting a communication deteriorated state in a state where a location registration is performed to the mobile radio communication network;
a second portion detecting a duration of the communication deteriorated state; and
a third portion notifying the mobile radio communication network to cut the duration from a duration of accounting.

7. The accounting control device in the mobile radio communication network as claimed in claim 6, wherein the communication deteriorated state comprises a call disable state.

8. The accounting control device in the mobile radio communication network as claimed in claim 6, wherein the communication deteriorated state comprises a communication disable state during a voice/packet communication.

9. The accounting control device in the mobile radio communication network as claimed in claim 6, wherein the communication deteriorated state comprises a communication disconnection state.

10. The accounting control device in the mobile radio communication network as claimed in claim 7, wherein when the call disable state continues for more than a fixed duration, the notification is not performed.
